(19) United States
(12) Patent Application Publication
(10) Pub. No.: US 2004/0080706 A1
(43) Pub. Date: Apr. 29, 2004

(54) Eyewear for lazy eyes or dyslexia

(76) Inventor: Newton Howard, Arlington, VA (US)

Correspondence Address: Newton Howard, Suite 718, 1600 North Oak Street, Arlington, VA, 22209, US

(21) Appl. No.: 10/279,118

(22) Filed: Oct. 24, 2002

(51) Int. Cl. G02C 1/00

(52) U.S. Cl. 351/41

(57) ABSTRACT

The present invention provides eyewear for individuals with lazy eyes or dyslexia.

### BACKGROUND OF THE INVENTION

1. Field of Invention

The invention generally relates to improving the quality of people's lives by correcting an individual's impaired vision.

2. Description of Related Art

Corrective eyewear has been around for hundreds of years. It has been used over the centuries to help individuals see. However, eyewear has not been readily available to the general public until the last half century. Before, eyewear was very expensive because it had to be custom made by hand. Not until recently have the cost of eyewear decreased to the point that almost everyone who needs them can afford them. Eyewear is now mass-produced, thus reducing the cost to the public and allowing access to more people.

Unfortunately, the eyewear currently on the market does not take into account an individual's own physical features. Currently, eyewear is standardized and applied to all individuals. However, society is composed of different races with different physical characteristics. Individuals are composed of their parents' DNA and ultimately inherit their physical characteristics. An individual may also have physical impairments that affect one's vision, for example, lazy eye or dyslexia. Unfortunately, today's eyewear does not take the differences of people's faces and visual impairments into their design.

Therefore, there is a need for eyewear that can accommodate the physical differences in people. There is a need for eyewear that can accommodate people's visual impairments. The present invention addresses these needs.

### SUMMARY OF THE INVENTION

An eyewear comprising a front frame; a lens; and a nosepiece. The eyewear wherein the front frame is attached to a side frame with a connector between the front frame and side frame. The eyewear wherein the side frame is attached to an earpiece. The eyewear wherein a lens is attached to the front frame using a lens connector. The eyewear wherein the nosepiece is attached to the front frame using an adjustable nose extender. The eyewear wherein the lens is attached to the front frame using a lens connector. The eyewear used to accommodate individuals with lazy eye or dyslexia.

### BRIEF DESCRIPTION OF THE DRAWINGS

The preferred embodiments of this invention will be described in detail, with reference to the following figures, wherein:

FIG. 1 is a first embodiment of an eyewear for lazy eyes or dyslexia;

FIG. 2 is a front view of the eyewear in FIG. 1;

FIG. 3 is a partial view of the frames for the eyewear in FIG. 1;

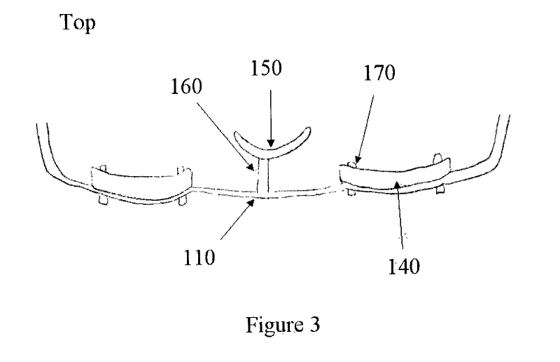

FIG. 4 is a partial view of a nosepiece for the eyewear in FIG. 1;

FIG. 5 is a second embodiment of the eyewear for lazy eyes or dyslexia;

FIG. 6 is a third embodiment of the eyewear for lazy eyes or dyslexia;

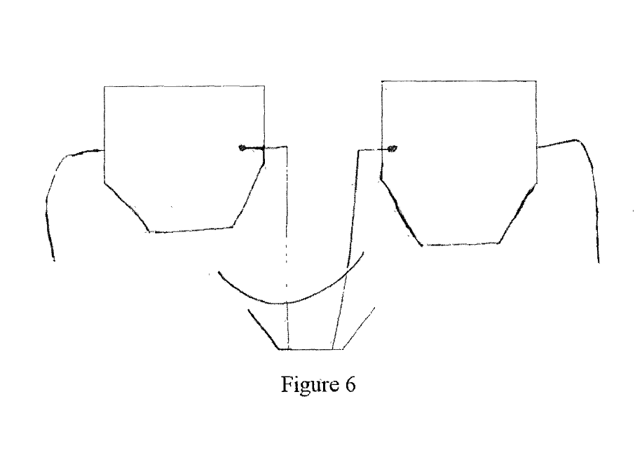

FIG. 7 is a top view of an adjustable nose extender for the eyewear in FIG. 1.

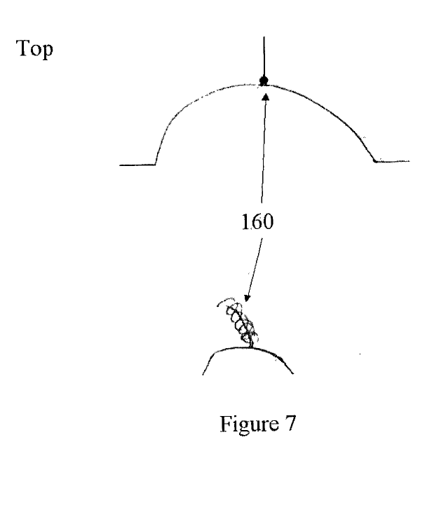

### DETAILED DESCRIPTION OF THE INVENTION

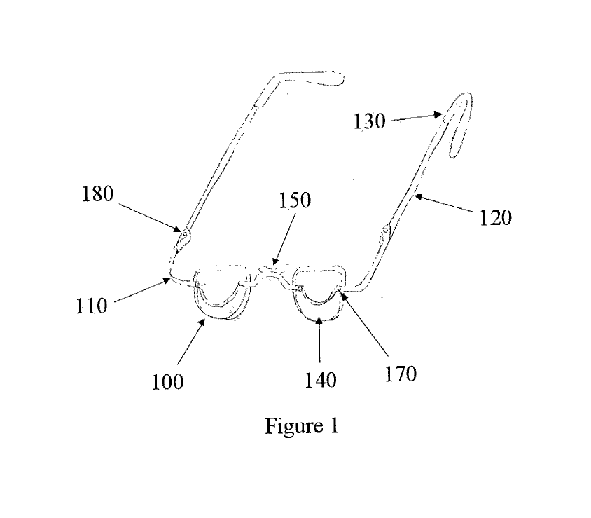

FIG. 1 shows one exemplary embodiment of an eyewear for individuals with lazy eyes or dyslexia 100. A front frame 1 10 of the present invention is connected to a side frame 120 (left and right) using a connector between the front frame and side frame 180. One connector between the front frame and side frame 180, as known in the art, is used for each side of the eyewear.

The connector between the front frame and side frame 180 may be a screw, hinge or other device that holds two pieces together that allows the pieces to move. The connector between the front frame and side frame 180 preferably lies flush with the front frame 110 and side frames 120. One connector between the front frame and side frame 180 is used on the left side of the eyewear 100 and one is used for the right side.

The first embodiment of the invention may or may not have an earpiece 130, as known in the art. Connected to each side frame 120 is an earpiece 130. There are earpieces 130 for each side of the first embodiment of the present invention, as shown in FIG. 1.

The front frame 110 and the side frames 180 are made with material known in the art, but preferably from metal as in the first embodiment of the invention. The front frame 110 and the side frames 180 are also manufactured using techniques known in the art.

The preferable width of the front frame 110 is X cm or less. The width of the front frame should be rounded with the width larger at the bridge area than the eye area. The preferable width being Y at the lens area and Z at the bridge area. However, the width at the lens area could be any width less than A and the width at the bridge area could be any width less than B, as long as the width at the lens area is less than the width at the bridge area. This is completely opposite to traditional eyewear. Eyewear in the known art the bridge is a smaller in width than the lens area.

The larger bridge size provides several advantages. First, it gives a unique cosmetic appearance, not seen in the known art. Second, the design gives a conic area of vision. Third, the design reduces the lens size.

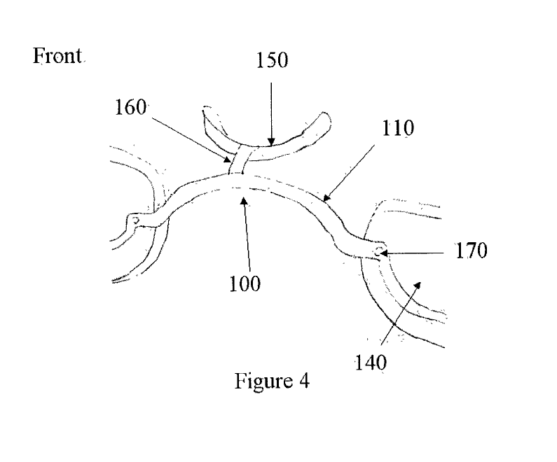

A nosepiece 150 is also connected to the front frame 110 using an adjustable nose extender 160, as shown in FIG. 4. The adjustable nose extender is adjustable to fit the face of various individuals. The adjustable nose extender can move the front frame 110 backwards and forwards to fit the eyewear 100 owner's individual features. The adjustable nose extender is used to accommodate “fat faced” individuals, people with high cheekbones and people with deep inset eyes. Currently, no eyewear available has this feature.

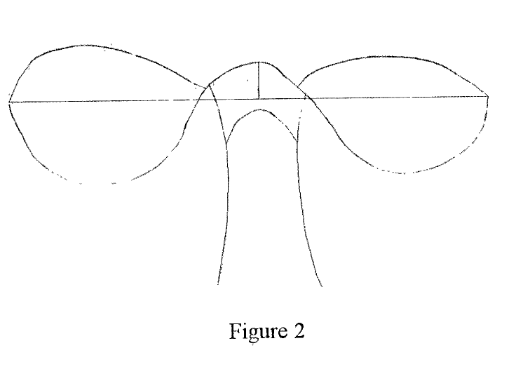

FIG. 2 shows a front view of the first embodiment of the present invention.

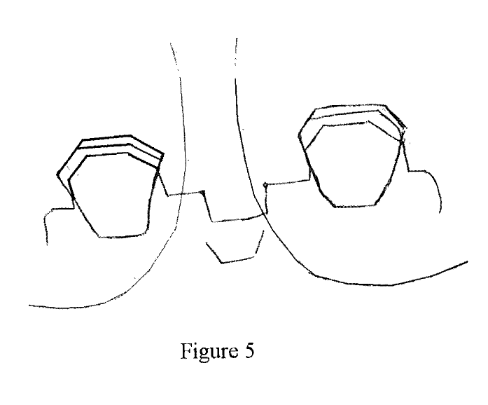

The lenses 140 of the present invention do not have to be rounded, as shown in FIG. 1. The lenses 140 may be any shape as long as the top of the lens 140 is straight beneath the wearer's eyebrows. FIG. 5 shows a front view of a second embodiment of the present invention. In this embodiment, the lenses 140 are six-sided.

What is claimed is:

1. An eyewear, comprising:
a front frame;
a lens; and
a nosepiece.

2. The eyewear according to claim 1, wherein the front frame is attached to a side frame with a connector between the front frame and side frame.

3. The eyewear according to claim 2, wherein the side frame is attached to an earpiece.

4. The eyewear according to claim 1, wherein a lens is attached to the front frame using a lens connector.

5. The eyewear according to claim 1, wherein the nosepiece is attached to the front frame using an adjustable nose extender.

6. The eyewear according to claim 1, wherein the lens is attached to the front frame using a lens connector.
